(19) United States
(12) Patent Application Publication
(10) Pub. No.: US 2023/0104464 A1
(43) Pub. Date: Apr. 6, 2023

(54) Hybrid Transmission Arrangement and Hybrid Drive Train

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Michael Wechs, Weißensberg (DE); Thomas Martin, Weissensberg (DE); Johannes Kaltenbach, Friedrichshafen (DE); Martin Brehmer, Tettnang (DE); Peter Ziemer, Bad Woerishofen (DE); Max Bachmann, Friedrichshafen (DE); Mladjan Radic, Langenargen (DE); Ingo Pfannkuchen, Friedrichshafen (DE); Christian Michel, Ravensburg (DE)

(21) Appl. No.: 17/960,616

(22) Filed: Oct. 5, 2022

(30) Foreign Application Priority Data
Oct. 6, 2021 (DE) 10 2021 211 240.4

(51) Int. Cl. B60K 6/365; F16H 37/08; B60K 6/442; B60K 6/547; B60K 6/387; B60K 6/40; B60K 17/354; B60K 17/356

(52) U.S. Cl. CPC B60K 6/365; F16H 37/082; B60K 6/442; B60K 6/547; B60K 6/387; B60K 6/40; B60K 17/354; B60K 17/356; F16H 2200/0056; B60K 2006/541

(57) ABSTRACT

A hybrid transmission arrangement (10) for a motor vehicle (30) includes a transmission (11), a third planetary gear set (PS3), and a first electric machine (EM1). The transmission (11) includes a first input (14), which is connectable to an internal combustion engine (VM), a second output (22), a third output (23), and at least one planetary gear set (PS1, PS2). The third planetary gear set (PS3) includes a first element (S3;H3′), a second element (H3;S3′), and a third element (P3;P3′). The third planetary gear set (PS3) is interlockable using a first shift element (E) and arranged coaxially to a first axis (A1). The first element (S3;H3′) is connected to the first electric machine. The second element (H3;S3′) is connected to the second output (22) of the transmission (11). The third output (23) of the transmission (11) is connected to the first element (S3;H3′). The third element (P3;P3′) is connected to a drive output (Ab) of the hybrid transmission arrangement (10).

### CROSS-REFERENCE TO RELATED APPLICATION

The present application is related and claims priority to 102021211240.4 filed in the German Patent Office on Oct. 6, 2021, which is incorporated by reference in its entirety for all purposes.

### FIELD OF THE INVENTION

The present invention relates generally to a hybrid transmission arrangement for a motor vehicle, the hybrid transmission arrangement having a transmission including multiple planetary gear sets and a first electric machine.

The present invention further relates generally to a hybrid drive train for a motor vehicle, the hybrid drive train having a hybrid transmission arrangement.

### BACKGROUND

Hybrid drive trains for motor vehicles generally have an internal combustion engine, which can provide drive power for driving the motor vehicle, and an electric machine, which can provide drive power for the motor vehicle alternatively or in addition to the internal combustion engine depending on the operating mode.

With respect to hybrid drive trains, a distinction is made between a plurality of different concepts, each of which provides a different connection of the electric machine to a transmission arrangement of the hybrid drive train.

For example, it is known to arrange an electric machine concentrically to an input shaft, wherein a rotor of the electric machine is connected to a hollow shaft, which is arranged around an input shaft.

In many cases, the electric machine is connected via a pre-ratio to a transmission arrangement of the hybrid transmission. The pre-ratio can include a planetary gear set arrangement.

Document DE 10 2013 215 114 A1 describes a hybrid drive of a motor vehicle, in which an electric machine is connectable via a spur gear train to an output shaft of a hybrid transmission. It is also known from this document to arrange an electric machine coaxially to a transmission output shaft and, in fact, axially offset with respect to a planetary gear set, which is designed as a superposition gearbox for electric motor-generated drive power and for internal combustion engine-generated drive power.

Hybrid transmissions are preferably designed as powershift transmissions. When installed in a motor vehicle transversely to the drive direction (front-mounted transverse or rear-mounted transverse), the axial installation length of the hybrid transmission is of great significance. Moreover, the installation surroundings frequently must be taken into account in the case of an installation transversely to the direction of travel. Constrictions are, possibly, a joint of sideshafts, transmission mounting brackets, and/or a lower vehicle longitudinal member.

### SUMMARY OF THE INVENTION

Example aspects of the present invention provide an improved hybrid transmission arrangement and an improved hybrid drive train for a motor vehicle, wherein the hybrid transmission arrangement is designed to be compact and/or has a large range of functions and, preferably, can be readily installed transversely in a motor vehicle.

The hybrid transmission arrangement has: a transmission, which includes a first input, which is connectable to an internal combustion engine, a second output, a third output, and at least one planetary gear set; a third planetary gear set, which includes a first element, a second element, and a third element, the third planetary gear set being interlockable using a first shift element and arranged coaxially to a first axis; and a first electric machine, wherein the first element is connected to the first electric machine, and wherein the second element is connected to the second output of the transmission, wherein the third output of the transmission is connected to the first element, and wherein the third element is connected to a drive output of the hybrid transmission arrangement.

In a broader form, a hybrid transmission arrangement for a motor vehicle may include a transmission, which includes a first input, two outputs, and at least a first planetary gear set, preferably two planetary gear sets, and which can establish preferably three through five, in particular four, gear steps.

Moreover, the hybrid drive train for a motor vehicle, which has a first axle and a second axle, may include the hybrid transmission arrangement according to example aspects of the invention for driving the first axle and preferably having an electric axle drive for driving the second axle.

The hybrid transmission arrangement enables a radially compact design. The transmission is preferably implemented by planetary gear sets. The hybrid transmission arrangement can preferably be implemented overall without spur gear stages.

The hybrid transmission arrangement enables a superposition of internal combustion engine-generated power and of electric motor-generated power, which is provided by the first electric machine. Moreover, a driving operation under purely electric motor power is possible and, in fact, preferably in at least one electric motor gear step.

With the hybrid transmission arrangement, at least two, preferably precisely four, internal combustion engine gear steps, as well as at least one, preferably precisely two, electric motor gear steps can be established.

Internal combustion engine-generated power and electric motor-generated power can be superimposed in the third planetary gear set. The third planetary gear set can be utilized as an electrodynamic starting element (EDA). In this case, a superimposing of the internal combustion engine speed, a rotational speed of the first electric machine, and the rotational speed of the drive output takes place. The first electric machine can support a torque. Consequently, it is possible to pull away from rest with the internal combustion engine running.

The hybrid transmission arrangement allows for a support of tractive force in the hybrid operation using the first electric machine. In particular, it is possible in this case to carry out “output-assisted” gear shifts, in which the first electric machine is connected with a fixed ratio toward the drive output and supports the tractive force solely under electric motor power. In the meantime, the internal combustion engine can carry out a load-free gear shift, as is the case with an automated manual transmission, in the background.

The hybrid transmission arrangement can be implemented without conventional powershift elements (brakes and friction clutches). Instead, all shift elements can preferably be implemented as dog clutches, i.e., as purely form-locking shift elements.

In addition, a series of other hybrid functions is also possible with the hybrid transmission arrangement, such as, for example, an internal combustion engine start (in particular using a high-voltage starter generator), a load point displacement, and a recuperation.

In one preferred example embodiment, the internal combustion engine and the first electric machine can be connected to each other without interlocking the third planetary gear set. Here, charging in neutral can be implemented, in which the internal combustion engine drives the first electric machine as a generator.

Moreover, good gearing efficiencies can be implemented overall and, in fact, with the internal combustion engine and with the electric motor. In addition, the transmission losses are low, since constant-mesh shift elements can be utilized. A good transmission ratio range can also be established. The hybrid transmission arrangement can also be structurally implemented such that shift elements are readily accessible by actuation devices (actuators).

The hybrid transmission arrangement is preferably implemented as a group transmission having two transmission groups connected in series and a downstream EDA planetary gear set, which can be interlocked using the first shift element.

Despite having a radially compact design, the hybrid transmission arrangement can be implemented having few radial planes, so that an axially comparatively compact design is also possible.

The hybrid transmission arrangement preferably also includes at least a second electric machine, which is preferably designed in the manner of a high-voltage starter generator (HVSG) and is connected to the input of the first transmission group.

The number of actuation devices for actuating shift elements of the hybrid transmission arrangement is preferably precisely three or four, in addition to an actuation device for a separating clutch, provided that a separating clutch is provided.

The hybrid transmission arrangement is preferably installed transversely in a motor vehicle and, in fact, is preferably mounted transversely in the front.

A hybrid drive train for a motor vehicle, which has a first axle and a second axle, is preferably equipped with this type of hybrid transmission arrangement for driving the first axle. It is particularly preferred when an electric axle drive is provided at the second axle for driving the second axle. In this case, the drive train preferably has at least two electric machines for driving. It is particularly preferred when the at least two electric machines of the drive train are supplied from a common battery of the motor vehicle. Preferably, at least one of the electric machines is also configured to charge the battery during operation as a generator.

A driving operation in reverse is preferably carried out exclusively under electric motor power. A mechanical reverse gear step is therefore preferably not provided.

The following terms are to be understood within the scope of the present disclosure in particular as follows:

A gear pair has precisely two gearwheels, which are engaged with each other, in particular intermeshing with each other. The gearwheels of a gear pair preferably each have a spur gear tooth system, are preferably arranged in a radial plane, and are preferably assigned to different shafts. The gearwheels of the gear pair can be two fixed gears (constant gear set). In a shiftable gear pair, the two gearwheels can be a fixed gear and an idler gear (see below), which, together, preferably define a gear step (see below).

One gear set (spur gear train) has at least two mutually engaging (in particular intermeshing) gearwheels and can have one or multiple gear pair(s), which is/are preferably situated in a common radial gear set plane. If a gear set has a fixed gear that is engaged with two different gearwheels, this is also referred to as a dual use of the fixed gear. In general, a gear set can also be a planetary gear set.

An idler gear is a gearwheel that is rotatably mounted at a shaft and is connectable to or decoupleable from the shaft using a shift element. A fixed gear is a gearwheel that is rotationally fixed at a shaft.

A shift element (or a clutch) is utilized for connecting or releasing elements, such as an idler gear and a shaft or a shaft and a housing, and is formed, in particular, by a gearshift clutch in the present case, in particular a form-locking gearshift clutch, such as a dog clutch. The shift element can also be a friction clutch or a form-locking synchronous gearshift clutch, however. The term of the shift element is to be equated with the term of a clutch.

A double shift element has two shift elements, which are preferably assigned to different elements and are alternately engageable using a single actuation device. Moreover, the double shift element preferably has a neutral position in which neither of the two shift elements is engaged.

Two elements that are rotatable in relation to each other are connected when the two elements necessarily rotate with a proportional rotational speed. The term “connected” is to be equated with “operatively connected.” A “rotationally fixed connection” is to be understood to mean that the two elements rotate at the same rotational speed. Two elements are connectable for the case in which the two elements can either be connected to each other or decoupled from one another. Preferably, the two elements are connectable to each other using a shift element (for example, a gearshift clutch or a brake).

Two elements are axially aligned when the two elements at least partially overlap in the axial direction and/or when the two elements are situated in a common radial plane. The term of the radial plane is preferably to be understood as functional and not geometric. Consequently, two shift elements of a double shift element can also be situated in a common radial plane.

A planetary gear set is interlockable when two of the elements of the planetary gear set are connectable using a shift element, although in the present case this should also include when one of the elements is fixable with respect to a housing using a shift element. Due to an interlock, a fixed ratio of the planetary gear set is consequently established.

An internal combustion engine gear step enables a driving operation under purely internal combustion engine power, although the internal combustion engine gear step also always enables electric motor-generated power to be superimposed on the internal combustion engine-generated drive power. For a “boost” driving operation, positive electric motor-generated power is superimposed. For a recuperation driving operation, negative electric motor-generated power is superimposed. Internal combustion engine gear steps can therefore also be referred to as hybrid gear steps, and vice versa.

An electric motor gear step enables a driving operation under purely electric motor power.

In general, the transmission, which can preferably establish three through five, in particular precisely four, gear steps, can be implemented as a spur gear drive or as planetary gear sets coupled to one another.

Preferably, the transmission is designed having a first transmission group, however, which includes the first input, a first output, and a first planetary gear set, and having a second transmission group, which includes a second input, the second output, the third output, and a second planetary gear set, wherein the second input of the second transmission group is connected to the first output of the first transmission group.

The first transmission group and/or the second transmission group each have at least one planetary gear set, preferably precisely one planetary gear set. The first transmission group and/or the second transmission group preferably do not/does not have a spur gear train. The first transmission group and the second transmission group are each arranged on a single axis. The axes of the two transmission groups can be different, however. The first transmission group is preferably arranged coaxially to a drive shaft of an internal combustion engine. The second transmission group is preferably arranged coaxially to a differential of the output drive and, in fact, preferably around one of the output shafts of the differential. Accordingly, the hybrid transmission arrangement can be arranged on essentially two axes such that a radially compact design is possible.

According to one preferred example embodiment, the first transmission group has two shift elements, which are coupled to the first planetary gear set and to the first input and to the first output such that two different ratios are establishable between the first input and the first output. Alternatively or additionally, the second transmission group has two shift elements, which are coupled to the second planetary gear set and to the second input and to the second output and to the third output such that two different ratios are establishable between the second input and the second output, on the one hand, and between the second input and the third output, on the other hand.

The coupling of the shift elements can take place, for example, such that both shift elements of one transmission group are connected to the particular input. Moreover, one of the shift elements can be connected to an element of the planetary gear set of the transmission group, the element being connected to the second output or to the third output. The other shift element can preferably be connected to the other output of the particular transmission group.

Consequently, it is possible in each transmission group to establish two different ratios using two shift elements and one planetary gear set.

Each transmission group can therefore be designed to be radial as well as compact.

It is particularly preferred in this case when the two shift elements of the first transmission group are connected to the first planetary gear set and to the first input and to the first output such that one of the two ratios between the first input and the first output is a direct drive and the other ratio is greater than one (1) or less than one (1).

In a corresponding way, it is alternatively or additionally preferred when the two shift elements of the second transmission group are connected to the second planetary gear set and to the second input and to the second output and to the third output such that one of the two ratios between the second input and the second output or the third output is a direct drive and the other ratio is greater than one (1) or less than one (1).

In both cases, one of the shift elements is configured to directly connect the particular input and the particular output of the transmission group to each other. As a result, the particular direct drive (i=1) is established, i.e., the associated planetary gear set is practically by-passed.

The other shift element preferably connects the input of the particular transmission group to an element of the particular planetary gear set. Either a ratio greater than one (1) or a ratio less than one (1) can be established based on the selection of the element of the associated planetary gear set to which the shift element is connected.

In one preferred example variant for establishing a ratio greater than one (1) (corresponding to a low gear), the relevant shift element of the transmission group can be connected on the input side to the particular input of the transmission group and on the output side to a ring gear of the particular planetary gear set. In this case, for example, the planet carrier of the particular planetary gear set can be connected to an output of the particular transmission group. In this case, furthermore, a sun gear of the particular planetary gear set can be connected to a housing.

If, on the other hand, a ratio less than one (1) (corresponding to a higher gear) is to be implemented in addition to the direct drive, the output element of the associated shift element can be connected, for example, to the planet carrier of the planetary gear set of the transmission group, wherein the ring gear of this planetary gear set is connected to an output of the transmission group in this case. It is preferred in this case as well when the sun gear is connected to a housing.

In a first variant, it is possible to establish a ratio greater than one (1) in addition to the direct drive in each of the transmission groups. It is also possible to establish a ratio less than one (1) in addition to the direct drive in each of the two transmission groups. It is also possible to establish a ratio greater than one (1) in addition to the direct drive in one transmission group and to establish a ratio less than one (1) in the other transmission group.

Moreover, it is advantageous when the two shift elements of the first transmission group are formed by a first double shift element, which is arranged coaxially to the first planetary gear set, and/or when the two shift elements of the second transmission group are formed by a second double shift element, which is arranged coaxially to the second planetary gear set.

Consequently, the first transmission group can implement two different ratios using a single actuation device. Correspondingly, the second transmission group can implement two different ratios using a single actuation device. In connection with an actuation device for actuating the first shift element, by which the third planetary gear set is interlockable, the hybrid transmission arrangement can therefore be implemented with three actuation devices.

In particular for the case in which at least the double shift element of the second transmission group also enables a neutral position, a driving operation under purely electric motor power can be established in combination with a complete decoupling of the transmission groups.

Preferably, a neutral position can also be established in the double shift element in the first transmission group. In this case, it is possible to start an internal combustion engine, for example, using a high-voltage starter generator, which is connected to the input of the first transmission group, without the need to entrain elements of the transmission groups.

According to another example embodiment preferred overall, the second transmission group is arranged coaxially to the first axis, i.e., coaxially to the third planetary gear set. The second transmission group is preferably arranged coaxially to a second axis, which is arranged axially parallel to and offset from the first axis.

The second axis is preferably coaxial to an axis of an internal combustion engine when the hybrid transmission arrangement is installed in a motor vehicle.

Consequently, the hybrid transmission arrangement can be implemented with only two axes, wherein, if necessary, further axes can be provided for the first electric machine (in an axially parallel arrangement) and/or for the second electric machine (high-voltage starter generator).

Overall, it is particularly advantageous when the drive output has a differential, which is arranged coaxially to the first axis.

In this example embodiment, the third planetary gear set and the second transmission group are preferably arranged coaxially to the differential and are preferably arranged around one of the output shafts of the differential. In other words, one output shaft for transmitting drive power from the differential to one of the driven wheels of the motor vehicle extends in the axial direction through the third planetary gear set and through the second transmission group.

As a result, a particularly compact design is enabled.

According to another preferred example embodiment, the drive output between the third element of the third planetary gear set and a differential has a gear set having a constant ratio.

In general, the gear set can be a spur gear train. It is particularly preferred when the gear set is a planetary gear set, which has an element that is fixed at a housing and, consequently, establishes a constant ratio.

The gear set is functionally arranged between the third planetary gear set and the differential. It is particularly preferred when the gear set is also structurally arranged in the axial direction between the third planetary gear set and the differential. This yields a structurally particularly favorable arrangement coaxially to the first axis.

In general, the first electric machine can be arranged coaxially to the first axis.

It is particularly preferred, however, when the first electric machine is arranged axially parallel to and offset from the first axis and is connected to the first element of the third planetary gear set via a spur gear train or via a traction mechanism, for example, a belt or chain.

The spur gear train can include, for example, a gearwheel connected to a shaft of the first electric machine, a fixed gear rotationally fixed to the first element of the third planetary gear set, and, if necessary, an intermediate gearwheel arranged between these gearwheels, in order to establish a ratio adaptation.

The first electric machine in this example embodiment preferably overlaps with the second transmission group in the axial direction.

A driving operation under purely electric motor power is possible by engaging the first shift element, because the third planetary gear set is interlocked as a result and a purely electromotive drive can be established using the first electric machine. As a result, precisely one electric motor gear step can be established.

Preferably, one element of the third planetary gear set is connectable to a housing via a second shift element.

Due to this measure, another electric motor gear step can be established, in particular a lower electric motor gear step, which is suited, for example, for a reverse driving operation under electric motor power.

It is particularly preferred when the second shift element is designed to connect the second output of the second transmission group and, consequently, the second element of the third planetary gear set to the housing.

According to another preferred example embodiment, a second electric machine is connected to the first input of the first transmission group.

As mentioned above, the second electric machine is preferably a high-voltage starter generator and is utilized, for example, for starting a connected internal combustion engine. The second electric machine can also be utilized for recuperative purposes, however, in order, for example, to displace a load point. In general, charging in neutral using the second electric machine is also possible. The rated power of the second electric machine is preferably considerably lower, however, than the rated power of the first electric machine, preferably lower than one-half of the rated power of the first electric machine.

The first input of the transmission can be rotationally fixed to a drive shaft of the internal combustion engine.

In one particular example embodiment, the first input of the transmission is connected, however, to an output element of a separating clutch, the input element of which is connectable to a drive shaft of the internal combustion engine.

The separating clutch is preferably also designed as a dog clutch. The separating clutch enables a decoupling of the internal combustion engine from the hybrid transmission arrangement.

It is understood that, in all cases, an element for decoupling torsional vibrations, for example, a torsion damper, a dual-mass flywheel, etc., can be arranged between the first input of the transmission and the drive shaft of the internal combustion engine.

The inputs and outputs of the first transmission group and of the second transmission group are preferably implemented by shafts, wherein it is preferred when the first input is a first input shaft of the first transmission group, and/or when the first output is a first output shaft of the first transmission group, and/or when the second input is a second input shaft of the second transmission group, and/or when the second output is a second output shaft of the second transmission group.

The first input shaft and the first output shaft are preferably arranged coaxially to the second axis. The second input shaft and the second output shaft are preferably arranged coaxially to the first axis.

As mentioned at the outset, the first transmission group and the second transmission group can be arranged coaxially to each other.

It is particularly preferred, however, when the first output shaft and the second input shaft are arranged axially parallel and offset and are connected to each other via a spur gear train or a traction mechanism.

As a result, it is possible to arrange the first transmission group coaxially to the first axis and the second transmission group coaxially to the second axis.

Moreover, it is advantageous when the first planetary gear set and/or the second planetary gear set establish(es) a fixed ratio.

Alternatively or additionally, it is advantageous when the first planetary gear set and the second planetary gear set axially overlap with each other.

In particular, the first planetary gear set and the second planetary gear set can be arranged in a common radial plane.

The spur gear train (or the traction mechanism) connecting the first output shaft and the second input shaft can be arranged in another radial plane axially adjacent to this radial plane.

The internal combustion engine is preferably arranged on an axial side of these radial planes. The third planetary gear set is preferably arranged on an opposite axial side of these radial planes.

It is understood that the features, which are mentioned above and which will be described in greater detail in the following, are usable not only in the particular combination indicated, but rather also in other combinations or alone, without departing from the scope of the present invention.

### BRIEF DESCRIPTION OF THE DRAWINGS

Example embodiments of the invention are represented in the drawings and are explained in greater detail in the following description. Wherein:

FIG. 1 shows a schematic view of an example embodiment of a hybrid transmission arrangement;

FIG. 2 shows a gear shift matrix for the hybrid transmission arrangement from FIG. 1;

FIG. 3 shows a schematic view of a vehicle having a hybrid drive train;

FIG. 4 shows a schematic view of another example embodiment of a hybrid transmission arrangement;

FIG. 5 shows a schematic view of another example embodiment of a hybrid transmission arrangement;

FIG. 6 shows a modification of the transmission arrangement from FIG. 1 for establishing a second electric motor gear step;

FIG. 7 shows a modification of the hybrid transmission arrangement from FIG. 6;

FIG. 8 shows another example embodiment of a hybrid transmission arrangement;

FIG. 9 shows another example embodiment of a hybrid transmission arrangement;

FIG. 10 shows another example embodiment of a hybrid transmission arrangement;

FIG. 11 shows a schematic view of a transmission group for a hybrid transmission arrangement; and

FIG. 12 shows a schematic view of an alternative transmission group for a hybrid transmission arrangement.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

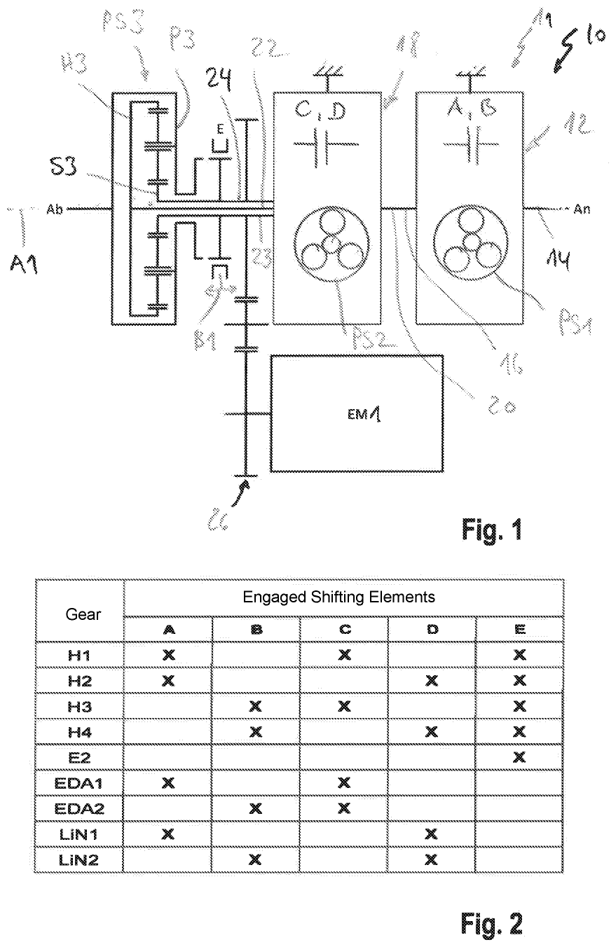

In FIG. 1, a first example embodiment of a hybrid transmission arrangement for a motor vehicle is schematically represented and is designated in general with 10.

The hybrid transmission arrangement 10 has a transmission 11 including a first transmission group 12 and a second transmission group 18. The transmission 11 or the first transmission group 12 has a first input shaft 14, which is connectable to a drive shaft An of an internal combustion engine (not represented in FIG. 1). The first transmission group 12 also has a first output shaft 16.

The second transmission group 18 has a second input shaft 20, which is connected to the first output shaft 16. Moreover, the transmission 11 or the second transmission group 18 has a second output shaft 22 and a third output shaft 23.

The first transmission group 10 has at least a first planetary gear set PS1 and at least one, preferably two, shift elements A, B, which is/are coupled to the first planetary gear set PS1, the first input shaft 14, and the first output shaft 16, in order to establish at least two different ratios using the first transmission group 12.

In a corresponding way, the second transmission group 18 has a second planetary gear set PS2 and one shift element or two shift elements C, D. The shift element or the shift elements is/are connected to the second planetary gear set PS2 as well as to the second input shaft 20, to the second output shaft 22, and to the third output shaft 23 such that two different ratios can be established using the second transmission group 18. In particular, the second transmission group 18 is designed such that, for the case in which one of the shift elements C, D is engaged (for example, C), drive power is supplied to one of either the second output shaft 22 or the third output shaft 23 (for example, 22). When the other of the shift elements C, D is engaged (for example, D), in this example embodiment, drive power is supplied to the other of either the second output shaft 22 or the third output shaft 23 (for example, 23).

Due to the provision of the second output shaft 22 and the third output shaft 23, it is therefore possible, on the one hand, to utilize one of the shift elements (for example, C) of the second transmission group 18 to supply internal combustion engine-generated power and electric motor-generated power into different elements of the third planetary gear set PS3, in order to establish an EDA mode, which is described in the following. On the other hand, it is also possible to utilize the other shift element (for example, D) of the second transmission group 18 to supply internal combustion engine-generated power and electric motor-generated power into the same element of the third planetary gear set PS3, in order to establish an LiN mode, which is described in the following.

The transmission 11 having the first transmission group 12 and the second transmission group 18 is therefore designed to establish four different ratios. In the present case, the transmission 11 is formed by the two transmission groups 12, 18 having planetary gear sets PS1, PS2, respectively. The transmission 11 can also be formed, however, by a spur gear drive or a type of transmission having four different ratios.

The hybrid transmission arrangement 10 also has a third planetary gear set PS3, which includes a sun gear S3, a ring gear H3, and a planet carrier P3. The ring gear H3 is connected, preferably rotationally fixed, to the second output shaft 22. The planet carrier P3 is connected to a drive output Ab of the hybrid transmission arrangement 10.

The hybrid transmission arrangement 10 also has a third input shaft 24, which is preferably arranged as a hollow shaft section around the second output shaft 22. The third input shaft 24 is connected, in particular rotationally fixed, to the third output shaft 23. The third input shaft 24 is connected via a spur gear train 26 to a first electric machine EM1, which is arranged axially parallel to and offset from the third input shaft 24 and preferably overlaps with the second transmission group 18 in the axial direction.

The third input shaft 24 and, consequently, also the third output shaft 23, are connected, in particular rotationally fixed, to the sun gear S3.

The third input shaft 24 is also connectable to the third planet carrier P3 using a first shift element E, in order to interlock the third planetary gear set PS3.

FIG. 2 shows a gear shift matrix for the hybrid transmission arrangement 10 from FIG. 1. In FIG. 2, engaged shift elements are marked with an “x.” Disengaged shift elements are characterized by blank table entries.

As is apparent from FIG. 2, four hybrid gear steps H1-H4 can be implemented using the hybrid transmission arrangement. A driving operation under purely internal combustion engine power is possible in each of these hybrid gear steps, although a superimposition of electric motor-generated power via the first electric machine EM1 is also possible.

The first shift element E is engaged in all four hybrid gear steps H1-H4, so that the third planetary gear set PS3 is interlocked. As a result, the first electric machine EM1 is directly connected to the drive output Ab.

In the first hybrid gear step H1, a shift element A in the first transmission group 12 is engaged and a shift element C in the second transmission group 18 is engaged. In the second hybrid gear step H2, the shift element A in the first transmission group 12 is engaged and a shift element D in the second transmission group 18 is engaged.

In the third hybrid gear step, a shift element B and the shift element C in the first transmission group 12 are engaged. In the fourth hybrid gear step, the shift element B in the first transmission group 12 is engaged and the shift element D in the second transmission group 18 is engaged.

Moreover, a single electric motor gear step E2 is establishable with the hybrid transmission arrangement 10 and, in fact, by engaging the shift element E and disengaging all shift elements A-D.

In addition, two different EDA modes are establishable, namely EDA1 and EDA2, using the hybrid transmission arrangement.

The first shift element E remains disengaged in all of these EDA modes. Consequently, internal combustion engine-generated drive power is supplied via the transmission groups 12, 18 into the ring gear H3 of the third planetary gear set PS3 (in classic EDA) or into the sun gear S3′ of the third planetary gear set PS3′. Torque can be “electrically” supported via the sun gear S3 or the ring gear H3′, so that an “EDA” starting operation is possible. A change-over from the first EDA mode EDA1 into the hybrid gear step H1 can then be carried out by engaging the first shift element E, since the shift elements A, C remain engaged and the shift elements B, D remain disengaged in this case.

Correspondingly, a change-over from the EDA mode EDA2 into the hybrid gear step H3 is possible and, in fact, by engaging the first shift element E. The shift elements B, C remain engaged and the shift elements A, D remain disengaged.

As mentioned above, driving under purely electric motor power can be implemented by engaging the first shift element E and disengaging the other shift elements. Starting from here, any hybrid gear step can be established by engaging two shift elements in the two transmission groups in each case. In the established hybrid gear step, internal combustion engine-generated power is additionally supplied to the drive output.

Gear ratio changes with support of tractive force between the hybrid gear steps are possible. In all cases, a support of tractive force is preferably implemented by supporting the drive output using the first electric machine EM1.

For example, a powershift from H1 to H2 in the hybrid mode takes place starting from engaged shift elements A, C, and E as follows. Initially, a load reduction takes place at the shift element C and a simultaneous load build-up takes place at the first electric machine EM1. Thereafter, the shift element C can be disengaged. The rotational speed of the internal combustion engine is reduced, so that the shift element D is synchronized. For this purpose, for example, a second electric machine in the form of a high-voltage starter generator, which is connected to the first input shaft 14, can operate as a generator. This is the preferred variant. Alternatively, when such a second electric machine is not present, the internal combustion engine can enter the coasting operation.

Thereafter, the shift element B can be engaged. The shift elements A and E remain engaged during the gear shift.

After the disengagement of the shift element C up to the engagement of the shift element D, the electric machine EM1 supports the tractive force entirely on its own.

The gear change into the other gear steps takes place in a similar way. In a gear change from H2 to H3, a load build-up takes place at the electric machine EM1, the two shift elements A and D are disengaged, the shift elements B and C are synchronized, and then the shift elements B and C are engaged.

With the hybrid transmission arrangement 10, according to FIG. 2, two different modes for charging in neutral (LiN1, LiN2) can also be established. In both cases, the first shift element E remains disengaged and the shift element D is engaged in both cases.

In LiN1, the shift elements A, D are engaged and the shift elements B, C are disengaged. Therefore, an internal combustion engine VM (via A and D) as well as the first electric machine EM1 are connected to the third output shaft 23 and the third planetary gear set PS3 is not interlocked. Consequently, the first electric machine EM1, when at a standstill, can be driven by the internal combustion engine VM, in order to operate the first electric machine EM1 as a generator and charge a connected electrical energy store (for example, a battery) or supply an electrical consumer. A consumer of this type can also be another electric machine, for example, an electric axle drive at another vehicle axle, as described in the following.

In LiN2, the shift elements B, D are engaged and the shift elements A, C are disengaged. Consequently, the same situation exists as in LiN1, except that the internal combustion engine VM is connected with a different ratio to the third output shaft 23 (via B and D instead of via A and D).

A change-over can be carried out from the LiN1 mode directly into the hybrid gear step H2, since the shift elements A, D are engaged in both modes. A change-over can be carried out from the LiN2 mode directly into the hybrid gear step H4, since the shift elements B, D are engaged in both modes.

The hybrid transmission arrangement 10 therefore has a transmission including two transmission groups connected in series, each of which is designed as a 2-speed transmission. Moreover, the hybrid transmission arrangement includes the downstream EDA planetary gear set PS3, which can be interlocked via the shift element E.

Each transmission group is preferably implemented by precisely one planetary gear set and two shift elements. In each transmission group, one shift element implements a lower gear and one shift element implements a higher gear. One of the two gears preferably corresponds to a respective direct drive (ratio i=1.0). The other of the two gears in each transmission group corresponds either to a ratio i>1.0 or a ratio i<1.0. The two shift elements are preferably designed as double shift elements.

A fixed ratio in the form of a planetary gear set or a spur gear train can be connected downstream from the third planetary gear set PS3, if necessary. Moreover, a differential is installed downstream either from the third planetary gear set PS3 directly or from the further fixed ratio. Drive power can be distributed onto driven wheels of the motor vehicle via the differential.

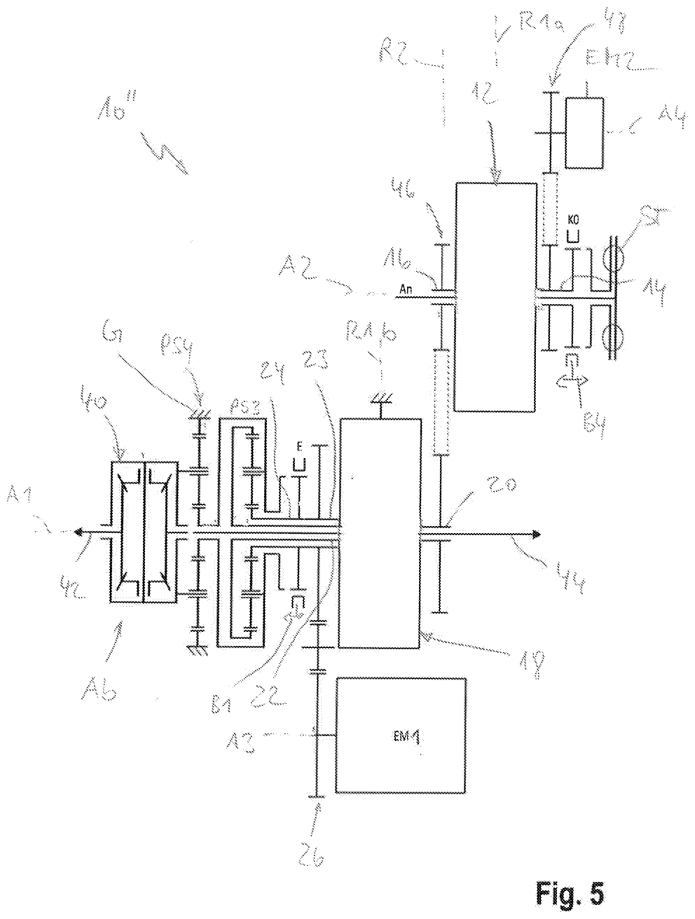

A separating clutch K0 can be connected between the first input shaft 14 and the internal combustion engine (see, for example, FIG. 5), in order to be able to decouple the internal combustion engine VM from the hybrid transmission arrangement. In all cases, it is preferred when an element for decoupling torsional vibrations is provided between the first input shaft 14 and the internal combustion engine VM.

The hybrid transmission arrangement 10 from FIG. 1 is preferably installed transversely in a motor vehicle and, in fact, is preferably mounted transversely in the front. Consequently, for example, a front-wheel drive or a rear-wheel drive of a motor vehicle can be implemented with the hybrid transmission arrangement.

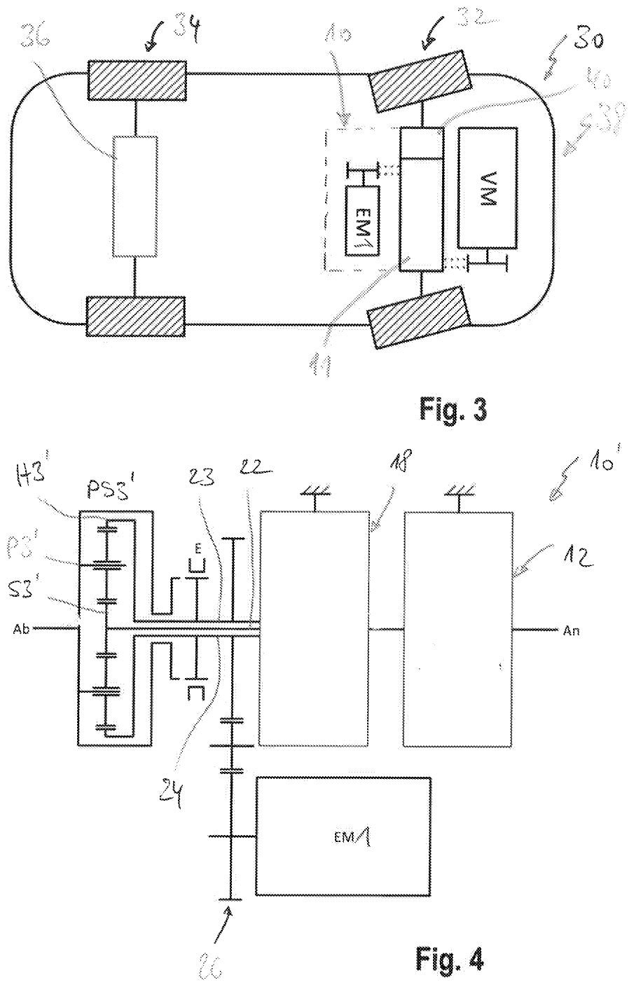

FIG. 3 shows an example of a motor vehicle 30, which has a first axle 32 and a second axle 34.

A hybrid transmission arrangement 10 of the type which is shown in FIG. 1 is arranged in the area of the first axle 32 and, in fact, in a front-mounted transverse arrangement. Moreover, an internal combustion engine VM, which is connected to the hybrid transmission arrangement 10, is arranged in the area of the first axle 32. The hybrid transmission arrangement 10 also has a differential 40 in addition to the transmission groups 12, 18. Drive power is distributable onto the driven wheels of the first axle 32 via the differential 40. The differential 40 is preferably arranged coaxially to at least one axis of the transmission 11.

An electric axle drive 36 is optionally arranged in the area of the second axle 34. The electric axle drive 36 can have one other electric machine and a mechanical differential or two other electric machines for the driven wheels of the second axle 34.

The internal combustion engine VM, the hybrid transmission arrangement 10, and the optional axle drive 36 form a hybrid drive train 38 for the motor vehicle.

An all-wheel drive system can be implemented with the hybrid drive train 38 shown in FIG. 3. A purely front-wheel drive, for example, can be established using the internal combustion engine, the first electric machine EM1, and the hybrid transmission arrangement 10. An additional rear-axle drive is possible using the electric axle drive 36.

Moreover, a power-split E-CVT mode for the internal combustion engine is possible. A battery-neutral operation is also possible in the power-split E-CVT mode.

Moreover, the tractive force can be supported using the electric axle drive 36 when change-overs in the hybrid transmission arrangement 10 are necessary, during which change-overs the drive output of the hybrid transmission arrangement 10 is to be load-free. Such change-overs are, for example, initially driving under purely electric motor power using the electric machine EM1 (and, if necessary, EM2) followed by an internal combustion engine start in neutral using the first electric machine EM1.

Further hybrid transmission arrangements, which generally correspond to the hybrid transmission arrangement from FIG. 1 and FIG. 2 with respect to configuration and mode of operation, are described below. Identical elements are therefore labeled with identical reference characters. Essentially the differences are explained in the following.

In FIG. 4 a hybrid transmission arrangement 10′ is shown, which, instead of the planetary gear set PS3 from FIG. 1, has a planetary gear set PS3′, which includes a sun gear S3′, a ring gear H3′, and a planet carrier P3′. The planet carrier P3′ is connected to the drive output Ab. In contrast to the example embodiment from FIG. 1, the ring gear H3′ is connected to the third input shaft 24 and, consequently, to the first electric machine EM1. The sun gear S3′ is connected to the second output shaft 22.

While the connection of the planetary gear set PS3 according to FIG. 1 is referred to as “classic EDA,” the connection of the planetary gear set PS3′ in FIG. 4 can also be referred to as “inverse EDA.”

The gear shift matrix from FIG. 2 can be applied in the same way to the hybrid transmission arrangement 10′ from FIG. 4. The same applies for the further hybrid transmission arrangements explained in the following.

In FIG. 5, a hybrid transmission arrangement 10″ is shown, which is based on the hybrid transmission arrangement 10 from FIG. 1 and FIG. 2.

The hybrid transmission arrangement 10″ from FIG. 5 has a first axis A1 and a second axis A2. The first transmission group 12 is arranged coaxially to the second axis A2. The second axis A2 is also arranged coaxially to a drive shaft An of the internal combustion engine. The drive shaft An is connected via a vibration damper ST to an input element of a separating clutch K0. The output element of the separating clutch K0 is connected to the first input shaft 14, which is arranged as a hollow shaft section around the drive shaft An. The drive shaft An can also be directly connected to the first input shaft 14 via the vibration damper ST. The first transmission group 12 has a radial plane R1a.

The second transmission group 18 is arranged coaxially to the first axis A1. The second transmission group 12 has a radial plane R1b.

The first electric machine EM1 is arranged axially parallel to and offset from the first axis A1 and is connected to the third input shaft 24 via the connection 26. The first electric machine EM1 can also be arranged coaxially thereto, however. The first electric machine EM1 is arranged on a third axis A3.

The drive output Ab of the hybrid transmission arrangement 10″ has a fourth planetary gear set PS4, which establishes a constant ratio between the planet carrier P3 of the third planetary gear set PS3 and a differential 40. The fourth planetary gear set PS4 has a ring gear (not described in greater detail), which is connected to a housing. A sun gear of the fourth planetary gear set PS4 is rotationally fixed to the planet carrier P3. A planet carrier (not described in greater detail) of the fourth planetary gear set PS4 is connected to an input element of the differential 40.

The differential 40 is arranged coaxially to the first axis A1, as is also the case for the fourth planetary gear set PS4 and the third planetary gear set PS3.

The differential 40 has a first output shaft 42 and a second output shaft 44, which are rotationally fixed to driven wheels of the motor vehicle. The fourth planetary gear set PS4, the third planetary gear set PS3, the spur gear train 26 for connecting the first electric machine EM1, the first shift element E, the double shift element D, C, and the second planetary gear set PS2 are arranged around the second output shaft 44 in the axial direction starting from the differential 40.

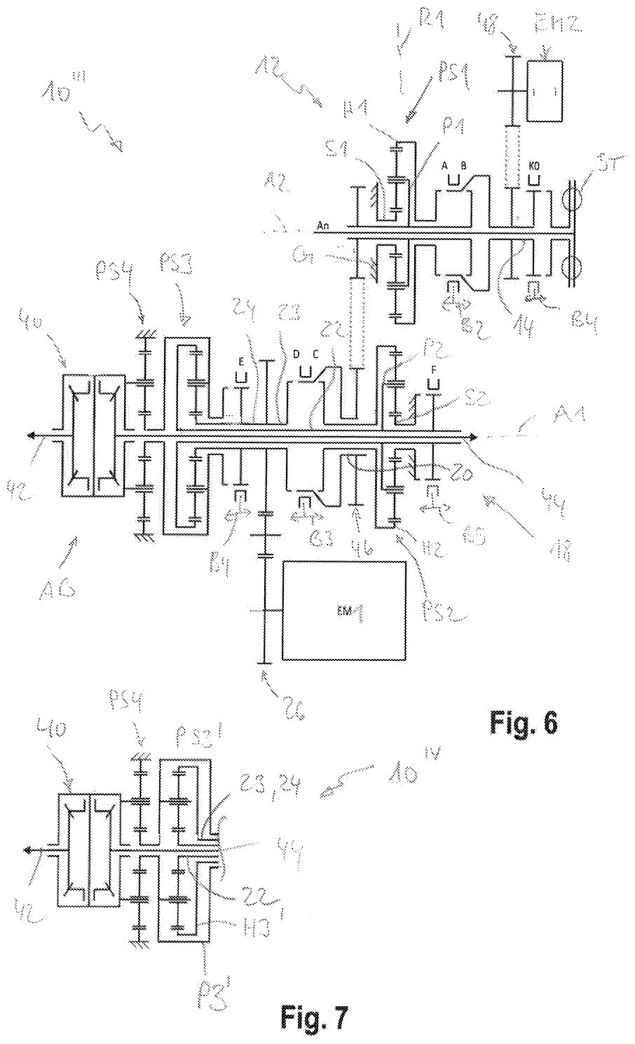

A connection between the first output shaft 16 and the second input shaft 20 is characterized with 46 in FIG. 5. This connection can be implemented by a spur gear train or by a traction mechanism, such as a chain. The connection 46 is situated in a radial plane R2, which can be arranged axially between the radial planes R1a, R1b, as shown in FIG. 5, or adjacent thereto, as shown in FIG. 6.

A second electric machine EM2, which can be designed as a high-voltage starter generator, is connected via a connection 48 to the first input shaft 14, although the second electric machine EM2 can also be arranged coaxially thereto. The second electric machine EM2 is arranged on a fourth axis A4. The further connection 48 can be implemented by a spur gear train or a traction mechanism.

The first shift element E is actuatable using a first actuation device B1.

In FIG. 6, another example embodiment of a hybrid transmission arrangement is shown, which corresponds to the hybrid transmission arrangement from FIG. 5 with respect to configuration and mode of operation.

Additionally, an optional second shift element F is provided, by which the second output shaft 22 is connectable to the housing G.

As a result, a second electric motor gear step E1 can be established, which establishes a lower ratio than the electric motor gear step E2 from FIG. 2, which is engaged using the first shift element E.

FIG. 6 also shows details of the transmission groups 12, 18 of the type which are also usable in the example embodiments from FIGS. 1, 4, and 5.

The first transmission group 12 has the first planetary gear set PS1, which is arranged in a first radial plane R1. The first planetary gear set PS1 has a sun gear S1, which is fixed at a housing G. The first planetary gear set PS1 also has a planet carrier P1, which is connected to the first output shaft 16. The first output shaft 16 is arranged as a hollow shaft section around the drive shaft An. The first input shaft 14 and the first output shaft 16 are arranged axially adjacent to each other.

The shift element A is designed to connect the first input shaft 14 to the ring gear H1 of the first planetary gear set PS1. The shift element B is designed to connect the first input shaft 14 directly to the first output shaft 16.

The ratio establishable using the shift element A is greater than one (1.0), and so a lower gear step is established using the shift element A than using the shift element B.

The second transmission group 18 has the second planetary gear set PS2, which is also arranged in the first radial plane R1. The second planetary gear set PS2 has a sun gear S2, which is fixed at the housing G. Moreover, the second planetary gear set PS2 has a planet carrier P2 and a ring gear H2.

The second input shaft 20 is arranged as a hollow shaft section around a shaft connected to the ring gear H2 and around the second output shaft 22 and is connected to the shift elements C, D. Furthermore, the shift element C is connected to the ring gear H2 of the second planetary gear set PS2. Furthermore, the shift element D is connected to the third output shaft and, consequently, also to the third input shaft 24. The planet carrier P2 of the second planetary gear set PS2 is connected to the second output shaft 22. The second input shaft 20 is directly connectable to the third output shaft 23 using a shift element D. The second input shaft 20 is connectable via the second planetary gear set PS2 to the second output shaft 22 using the shift element C.

In the second transmission group 18, a direct drive i=1 is established using the shift element D. Using the shift element C, a ratio greater than one (1) is established, corresponding to a lower gear step than using the shift element D.

The second planetary gear set PS2 is preferably arranged in the same radial plane R1 as the first planetary gear set PS1. The connection 46 is arranged adjacent thereto in the axial direction and, in fact, between the planetary gear sets PS1, PS2 and the double shift element D, C.

The second shift element F is arranged axially adjacent to the planetary gear set PS2, on an axial side opposite the connection 46. Since the shift elements E, F in the present case are situated axially at different positions, it is preferred when the second shift element F is actuatable using another actuation device B5 and, in fact, independently of the first shift element E. This independent actuation, in contrast to the implementation as a double shift element, can also have advantages in gear ratio changes from E1 to E3, and vice versa.

On the second axis A2, the double shift element A, B is arranged between the first planetary gear set PS1 and the first shaft 14 in the axial direction.

In other words, the double shift elements A, B and D, C are situated on axially opposite sides of the radial plane R1 formed by the planetary gear sets PS1, PS2.

In the hybrid transmission arrangements 10, 10′, 10″, and 10′″, a direct drive corresponding to the highest hybrid gear step H4 is established by engaging the shift elements B, D.

The shift elements A, B, which are implemented via a double shift element, are actuatable using a second actuation device B2. The shift elements C, D, which are implemented via a double shift element, are actuatable using a third actuation device B3. The separating clutch K0, provided this is present, is actuatable using a fourth actuation device B4.

FIG. 7 shows a detail from another hybrid transmission arrangement 10^{IV}, in which the transmission groups 12, 18 and the first electric machine EM1 are not represented. In comparison to the hybrid transmission arrangement 10′″ from FIG. 6, the hybrid transmission arrangement 10^{IV} has the alternative third planetary gear set PS3′ (inverse EDA).

The same table as shown in FIG. 2 is also usable for the hybrid transmission arrangements from FIG. 6 and FIG. 7.

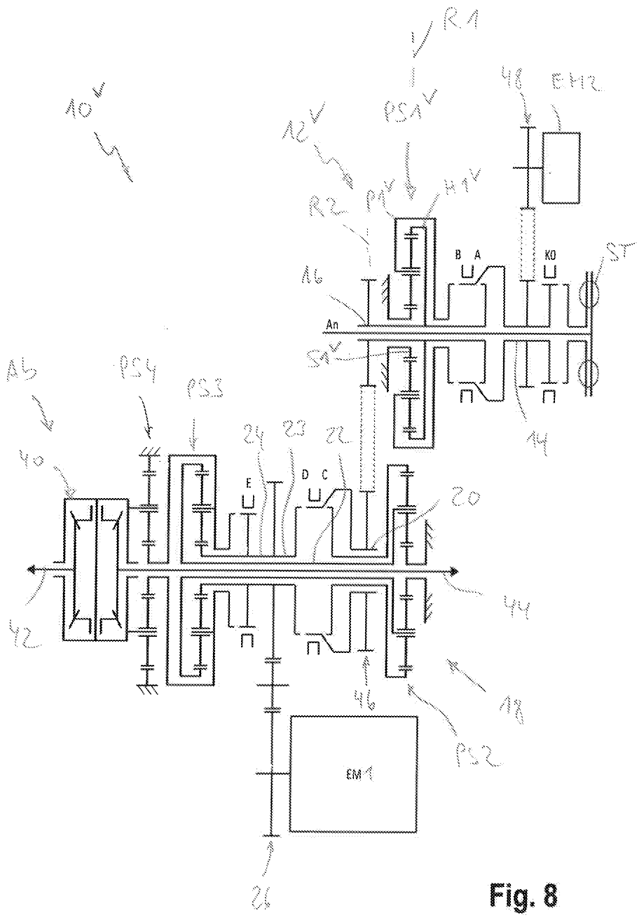

In FIG. 8, another example embodiment of a hybrid transmission arrangement 10^{V} is shown, which generally corresponds to the hybrid transmission arrangement 10″ from FIG. 6 with respect to configuration and mode of operation, without the second shift element F, which can also be provided here, however. Identical elements are therefore labeled with identical reference characters.

In the hybrid transmission arrangement 10^{V}, the first transmission group 12^{V} has a first planetary gear set PS1^{V}, which includes a sun gear S1^{V} connected to the housing and a ring gear H1^{V} connected to the first output shaft 16. The planet carrier P1^{V} is connected to a shift element B, by which the first input shaft 14 is connectable to the planet carrier P1^{V}. The shift element A is designed to directly connect the first input shaft 14 and the first output shaft 16 to each other and consequently establish a direct drive i=1.

In the alternative first planetary gear set PS1^{V}, a ratio that is less than one (1) is established by engaging a shift element B, and so a higher ratio is established using the shift element B than using the shift element A.

In the present case, the assignment of the shift elements to the identifiers A-D is selected in each case such that the highest ratio is established by the shift element A and the lowest ratio (lowest gear step) is established by the shift element D in each hybrid transmission arrangement.

In the hybrid transmission arrangement 10^{V}, a direct drive is established by engaging the shift elements A, D, corresponding to the hybrid gear step H2.

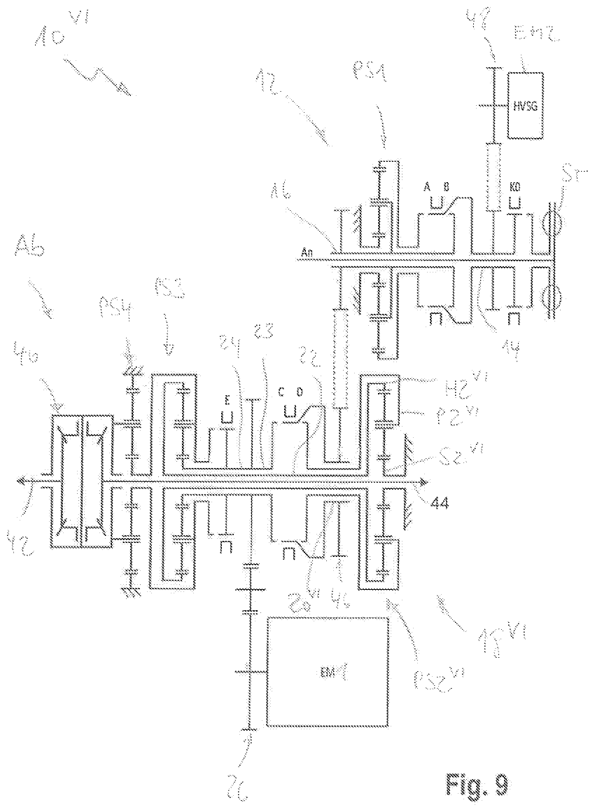

In FIG. 9 another hybrid transmission arrangement 10^{VI} is represented, which is based on the hybrid transmission arrangement 1′″ from FIG. 6 without the second shift element F, which can also be provided here, however.

In the second transmission group 18^{VI}, a second planetary gear set PS2^{VI} is provided, which has a sun gear S2^{VI} connected to the housing, a planet carrier P2^{VI}, which is connectable via the shift element D to the second input shaft 20^{VI}, and a ring gear H2^{VI}, which is connected to the second output shaft 22. The second input shaft 20^{VI} is connectable to the third output shaft 23 using the shift element C. A ratio less than 1.0, corresponding to a higher gear step, is established by the second planetary gear set PS2^{VI} using the shift element D.

A direct gear step is therefore established by engaging the shift elements B and C, corresponding to the hybrid gear step H3.

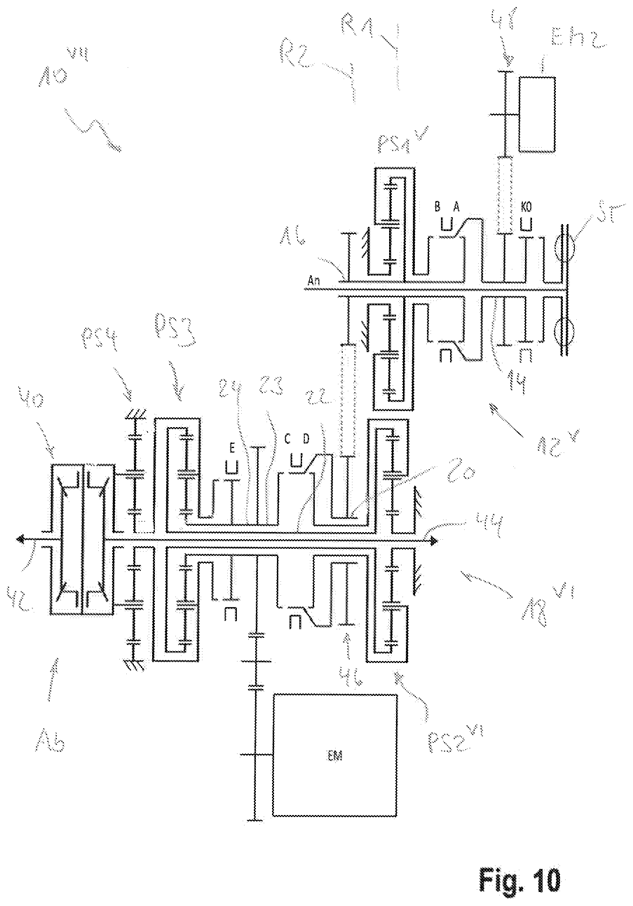

In FIG. 10, another hybrid transmission arrangement 10^{VII} is shown, which is based on the hybrid transmission arrangements from FIG. 8 and FIG. 9. The first transmission group 12^{V} has the first planetary gear set PS1^{V}, as in the example embodiment from FIG. 8. The second transmission group 18^{VI} has the second planetary gear set PS2^{VI}, as in the example embodiment from FIG. 9.

A direct gear step is therefore established by engaging the shift elements A and C, corresponding to the hybrid gear step H1.

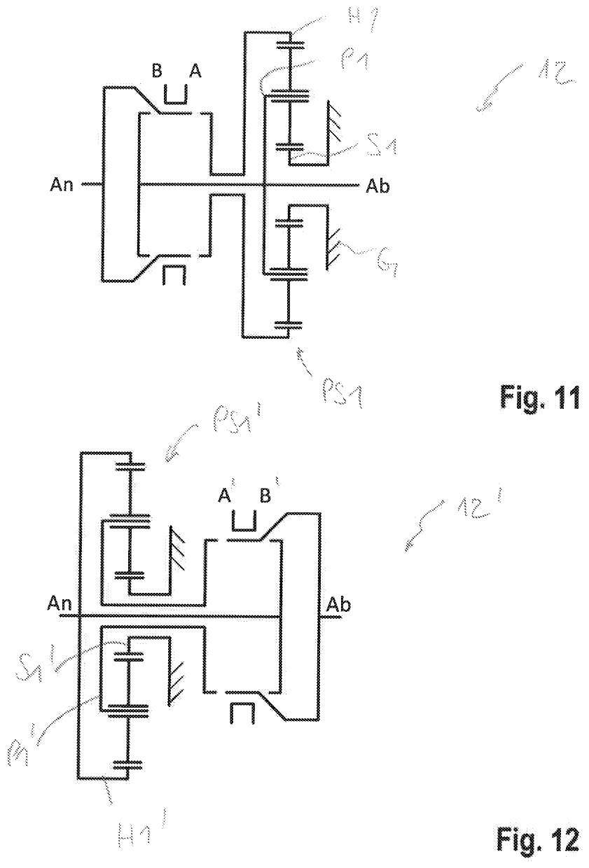

FIG. 11 and FIG. 12 each show exemplary representations of a planetary gear set together with a double shift element of the type which is implementable in each of the above-described transmission groups.

One of the shift elements is to by-pass the planetary gear set PS1 by connecting a drive shaft An and an output shaft Ab. The other shift element is to allow the planetary gear set to become active, so that the ratio i between the drive shaft An and the output shaft Ab is unequal to one (1.0).

There are multiple arrangement variants of these shift elements. On the one hand, there is an input-side arrangement of the double shift element between the drive shaft An and the planetary gear set, as shown in FIG. 11. The shift element B establishes the ratio i=1. The arrangement essentially corresponds to the double shift element A, B, which is shown in FIG. 5.

FIG. 12 shows an output-side arrangement of the shift element A′, B′ between the planetary gear set PS1′ and the drive output Ab. The shift element B′ is designed to establish the ratio i=1 in this case as well.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid transmission arrangement
11 transmission
12 first transmission group
14 first input shaft
16 first output shaft
18 second transmission group
20 second input shaft
22 second output shaft
23 third output shaft
24 third input shaft
26 connection EM1/24
30 motor vehicle
32 first axle
34 second axle
36 electric axle drive
38 hybrid drive train
40 differential
42 first output shaft
44 second output shaft
46 connection 16/20
48 connection EM2/14
PS1 first planetary gear set
S1 sun gear PS1
H1 ring gear PS1
P1 planet carrier/carrier PS1
PS2 second planetary gear set
S2 sun gear PS2
H2 ring gear PS2
P2 planet carrier/carrier PS2
PS3 third planetary gear set
S3 sun gear PS3
H3 ring gear PS3
P3 planet carrier/carrier PS3
PS4 fourth planetary gear set
E first shift element
F second shift element
A, B first double shift element 14
C, D second double shift element 18
B1-B5 actuation devices
A1-A4 axes
R1, R2 radial planes
EM1 first electric machine
EM2 second electric machine
VM internal combustion engine
Ab drive output
An drive shaft
ST vibration damper

1-15. (canceled)

16. A hybrid transmission arrangement (10) for a motor vehicle, comprising:
a transmission (11) with a first input (14) connectable to an internal combustion engine (VM), a second output (22), a third output (23), and at least one planetary gear set (PS1, PS2),
a third planetary gear set (PS3) with a first element (S3;H3′), a second element (H3;S3′), and a third element (P3;P3′), the third planetary gear set (PS3) interlockable by a first shift element (E) and arranged coaxially to a first axis (A1); and
a first electric machine (EM1),
wherein the first element (S3;H3′) is connected to the first electric machine, the second element (H3;S3′) is connected to the second output (22) of the transmission (11), the third output (23) of the transmission (11) is connected to the first element (S3;H3′), and the third element (P3;P3′) is connected to a drive output (Ab) of the hybrid transmission arrangement (10).

17. The hybrid transmission arrangement of claim 16, wherein the transmission (11) includes:
a first transmission group (12) with the first input (14), a first output (16), and a first planetary gear set (PS1); and
a second transmission group (18) with a second input (20), the second output (22), the third output (23), and a second planetary gear set (PS2), the second input (20) connected to the first output (16).

18. The hybrid transmission arrangement of claim 17, wherein:
the first transmission group (12) includes two shift elements (A, B) coupled to the first planetary gear set (PS1), the first input (14), and the first output (16) such that two different ratios are establishable between the first input (14) and the first output (16); and/or
the second transmission group (18) includes two shift elements (C, D) coupled to the second planetary gear set (PS2), the second input (20), the second output (22), and the third output such that two different ratios are establishable between the second input (20) and the second output (22) for one of the two different ratios and between the second input (20) and the third output (22) for the other of the two ratios.

19. The hybrid transmission arrangement of claim 18, wherein:
the two shift elements (A, B) of the first transmission group (12) are connected to the first planetary gear set (PS1), the first input (14), and the first output (16) such that one of the two ratios between the first input (14) and the first output (16) is a direct drive and the other ratio is greater than one or less than one; and/or
the two shift elements (C, D) of the second transmission group (18) are connected to the second planetary gear set (PS2), the second input (20), the second output (22), and the third output such that one of the two ratios between the second input (20) and the second output (22) or the third output (23) is a direct drive and the other ratio is greater than one or less than one.

20. The hybrid transmission arrangement of claim 18, wherein:
the two shift elements (A, B) of the first transmission group (12) are formed by a first double shift element arranged coaxially to the first planetary gear set (PS1); and/or
the two shift elements (C, D) of the second transmission group (18) are formed by a second double shift element arranged coaxially to the second planetary gear set (PS2).

21. The hybrid transmission arrangement of claim 17, wherein:
the second transmission group (18) is arranged coaxially to the first axis (A1), and/or
the first transmission group (12) is arranged coaxially to a second axis (A2) arranged axially parallel to and offset from the first axis (A1).

22. The hybrid transmission arrangement of claim 16, wherein:
the drive output (Ab) comprises a differential (40) arranged coaxially to the first axis (A1); and/or
the drive output (Ab) comprises a gear set (PS4) having a constant ratio between the third element (P3;P3′) of the third planetary gear set (PS3) and the differential (40).

23. The hybrid transmission arrangement of claim 16, wherein the first electric machine (EM1) is arranged axially parallel to and offset from the first axis (A1) and is connected to the first element (S3;H3′) of the third planetary gear set (PS3) via a spur gear train (26) or via a traction mechanism.

24. The hybrid transmission arrangement of claim 16, wherein one of the first, second, and third elements (H3;S3′) of the third planetary gear set (PS3) is connectable to a housing (G) by a second shift element (F).

25. The hybrid transmission arrangement of claim 16, further comprising a second electric machine (EM2) connected to the first input (14) of the transmission (11).

26. The hybrid transmission arrangement of claim 16, wherein the first input (14) of the transmission (11) is connected to an output element of a separating clutch (K0), the input element of the separating clutch (K0) connectable to a drive shaft (An) of an internal combustion engine (VM).

27. The hybrid transmission arrangement of claim 17, wherein:
the first input is a first input shaft (14) of the first transmission group (12); and/or
the first output is a first output shaft (16) of the first transmission group (12); and/or
the second input is a second input shaft (20) of the second transmission group (18); and/or
the second output is a second output shaft (22) of the second transmission group (18).

28. The hybrid transmission arrangement of claim 27, wherein the first output shaft (16) and the second input shaft (20) are arranged axially parallel and offset and are connected via a spur gear train or a traction mechanism (46).

29. The hybrid transmission arrangement of claim 16, wherein:
one or both of the first planetary gear set (PS1) and the second planetary gear set (PS2) establishes a fixed ratio; and/or
the first planetary gear set (PS1) and the second planetary gear set (PS2) axially overlap.

30. A hybrid drive train (38) for a motor vehicle (30), comprising:
a first axle (32);
a second axle (34);
the hybrid transmission arrangement (10) of claim 16 configured for driving the first axle (32); and
an electric axle drive (36) configured for driving the second axle (34).
